(19) United States
(12) Patent Application Publication
(10) Pub. No.: US 2019/0025543 A1
(43) Pub. Date: Jan. 24, 2019

(54) METHOD FOR PRODUCING A PHOTO- OR VIDEO-IMAGE OF AT LEAST ONE OBJECT TO BE RECORDED

(71) Applicants: Ivan Sergeevich SHISHALOV, Nizhny Novgorod (RU); Andrej Viktorovich FILIMONOV, Nizhny Novgorod (RU); Vladimir Vladimirovich PARHACHEV, Nizhny Novgorod (RU)

(72) Inventors: Ivan Sergeevich SHISHALOV, Nizhny Novgorod (RU); Andrej Viktorovich FILIMONOV, Nizhny Novgorod (RU); Vladimir Vladimirovich PARHACHEV, Nizhny Novgorod (RU)

(21) Appl. No.: 15/653,578

(22) Filed: Jul. 19, 2017

(51) Int. Cl. G02B 7/36; G02B 7/28; G06T 7/70

(52) U.S. Cl. CPC G02B 7/36; G06T 7/70; G02B 7/282

(57) ABSTRACT

The invention relates to the field of digital photo- and video-recording, and may be used for recording and monitoring distant objects, such as expanses of forest. The technical result is directed at enhancing the focus quality of the images produced. A method for producing a photo- or video-image of at least one object to be recorded, consisting in: producing an image of an object to be recorded by means of an electronic optical device; wherein, a focusing object, corresponding to at least one object to be recorded and satisfying the following conditions, is first selected for the object to be recorded: the focusing object has higher contrast than the object to be recorded, and the object to be recorded is located within the bounds of the depth of field. Then, an image is produced of the at least one object to be recorded, in which the electronic optical device is focused on the focusing object corresponding to the object to be recorded, the focusing parameters are set, and said focusing parameters are used for producing an image of the object to be recorded.

### CROSS-REFERENCE

The present application claims convention priority to Eurasian Utility Patent Application No. 201500120, filed on Jan. 19, 2015, entitled “ [symbol] [symbol] [symbol] [symbol] - [symbol] [symbol] [symbol] [symbol] IIO [symbol] [symbol] MEPE [symbol] [symbol] [symbol] ”. The present application is a continuation of international Patent Application no. PCT/RU2015/000808, filed on Nov. 20, 2015, entitled “METHOD FOR PRODUCING A PHOTO- OR VIDEO-IMAGE OF AT LEAST ONE OBJECT TO BE RECORDED”. This application is incorporated by reference herein in its entirety.

### FIELD OF THE INVENTION

The invention relates to the field of digital photo and video shooting, and can be used for shooting and monitoring remote objects, for example, such as forested areas.

### Definitions

For the purposes of presenting this application, the following concepts and definitions will be further applied, which are known and widely used in scientific and specialized literature.

The object of a shooting is an object or a part of it or several objects that are in the field of view of a photo- or video camera and are of immediate interest in performing the shooting or taking picture. In the case of a camera with a changeable viewing direction, objects that are in the field of view with different viewing directions can also be considered as objects of the shooting.

The background is the part of the image that is not the object of the shooting. In general, the background can be: sky, earth, other natural objects, part of a structure, etc.

Sharpness (clarity) is a feature that characterizes the visibility of details of an image. The image (or its part) is considered sharp (clear), if the details of the image, that is, the Objects or parts thereof, are visible on it to an extent, which is sufficient for a particular application. When shooting, the object should be sharp.

Focusing is the setting (selecting) of the camera lens's parameters, in which the image of the object becomes the sharpest.

The focus target is a special case of an object, the image of which is taken to set focus.

Contrast is a quantitative measure of the brightness ratio of adjacent elements of the image. If Pf is the brightness of one image's element, Po is the brightness of another image's element, then the contrast can be quantified as the absolute value (modulus) of the ratio (Pf−Po)/(Pf+Po). The higher is contrast, the more distinguishable are the elements of the image.

The object and the background can be regarded as the elements of an image. If contrast is high, then the object can be clearly distinguished from the background. The higher is contrast between the object and the background, the better the object is visible in the image.

Various parts of the object can also be regarded as elements of the image. The higher is contrast between the different parts of the object, the higher contrast of the object as a whole. Contrast objects (or contrasting parts of objects) should be selected as objects to focus on. The higher is contrast of the object, the easier it is to evaluate the distinguishability of its details, and therefore to assess object's sharpness in the image [1].

Depth of the sharply depicted space, Focusing depth (FD) is the distance along the optical axis of the lens between two planes in the space of objects, within which the objects are objectively imaged sharp in the conjugate focal plane. It directly depends on the most important characteristics of the optical system: the main focal length and the relative aperture, and also from the focusing distance. Wherein

$${R}_{1} = \frac{{Rf}^{2}}{{f}^{2} + K ( R - f ) z}$$

$${R}_{2} = \frac{{Rf}^{2}}{{f}^{2} - K ( R - f ) z}$$

R₁ is the front boundary of the sharply depicted space;

R₂ is the rear boundary of the sharply depicted space;

R is the distance in meters to which the focusing is applied;

f is a focal length of the lens, in meters;

K is a denominator of geometrical relative aperture of the lens, or the diaphragm number;

z is the diameter of the circle of blur or the allowable circle of scattering, for example, for negatives of 24×36 mm format, this circle is equal to 0.03-0.05 mm (the value in meters is substituted in the formula). For modern digital cameras it is equal to the pixel size of the matrix (for different matrices, these are different, including those equal to 0.003 mm). The permissible diameter of the circle of blur is determined by the requirements for the acutance of the image and may depend on the tasks to be solved.

The depth of the sharply depicted space P is determined by the difference between the back and front boundaries of sharpness: P=R₂−R₁.

Camera is a digital photo or video camera. With the modern development of the industry of optical electronic devices, the general principles of the implementation of photo and video cameras are very close, so further, by the term “camera” we mean one of these devices, but most often a video camera.

### BACKGROUND OF THE INVENTION

Modern photo and video cameras can be equipped with a rotary mechanism and are often equipped with a zoom mechanism (zoom lens), which allows using one camera to shoot objects in various directions with various zooming Such cameras can be used to shoot objects at a remote distance and monitor large areas. For example, by placing the camera on a natural or artificial high-rise object, you can inspect a large area of adjacent territories to detect fires, including forest fires.

The implementation of the applied set of devices, including the camera itself, the rotary device and zoom, assumes that the camera has the ability to focus on objects located at different distances from the camera's location point.

A system and method for video monitoring of forests is known (RF patent No. 2458407, IPC G08B 25/10, published on Oct. 8, 2012), as well as a method of controlling the monitoring system and a system for its implementation (RF patent No. 2504014, IPC G08B 17/00, G08B 25/10, published on 13 Jun. 2012) in which similar cameras are used.

Focusing (adjusting the sharpness) of a camera can be carried out in several methods. For example, manually, when the operator performs focusing by achieving optimum image quality on a viewfinder or a screen. Or automatically, when algorithms and mechanisms are implemented in a camera, allowing it to independently evaluate the current focusing parameters and adjust them to the optimum value. Frequently, contrast or phase autofocusing, described in numerous literature and the Internet, is used (https://en.wikipedia.org/wiki/Autofocus). Also, such methods are described, for example, in the patents of the Russian Federation Nos. 2456654, 2389050, 2528582.

Obviously, when using controlled cameras placed on high-altitude objects for video surveillance, monitoring, control of forest areas, the operator does not have the opportunity to adjust the focusing parameters in manual mode when the direction of the view is changed. Nowadays, the principle of automatic focusing is virtually implemented in all such cameras presented by manufacturers. The quality of the automatic focusing algorithm and the quality of the resulting image are different.

One of the problems of automatic focusing is the high complexity, and often the inability to focus when shooting scenes with low contrast, i.e. in the case when there is a small number of parts with sufficient sharpness available in the image frame.

This situation occurs, for example, when shooting distant objects in free space. In this case, the image quality of the objects is affected by the transparency (turbidity) of the atmosphere, which reduces the contrast and sharpness of distant objects, which has a significant effect on the quality of focusing, for example in the case of fog, smoke, and insufficient illumination.

This leads to the fact that when shooting, for example, along the route of patrolling a remote forestland (a sequence of points with different angles of inclination, rotation and approach in which the camera is shooting), the automatic camera focusing algorithm can often fail to determine the optimal value of the focusing parameters, and the camera will shoot a blurred image, which in turn will affect the quality of the video surveillance system performance of its main function. For example, when monitoring forestland, the user may not notice a fire due to the out-of-focus image obtained from the camera, which will lead to the untimely receipt by the user of information about the presence of burning and the spread of fire over a wide area.

A number of modern cameras feature the ability of setting focus as a specific value and storing focus parameters for each specific route of shooting, or a set of routes, which is a so-called absolute focusing. But this significantly complicates the design of a camera and reduces its reliability. Besides, in this case, the user has to manually adjust focus for each object (since under the above unfavorable shooting conditions, the automatic camera algorithm cannot cope with this task), which takes a long time, and can lead to errors related to human factor.

A method for producing a digital image of an object is known (RF patent No. 2429584, published on Sep. 20, 2011, IPC H04N5/235), chosen as the closest analogue, consisting in forming a series of digital images of the same object obtained at different exposure levels, the value of the parameter determining the effectiveness of the photographing is calculated or measured for each pixel of each digital image, using information from a totality of pixels of the image portion comprising the desired pixel and spaced from it at a predetermined distance, and then creating a resulting image, pixel by pixel, with each pixel of the resulting image being store with information in it from the adjacent pixel of the digital image, for which the previously obtained value of the parameter determining the photographing efficiency has an optimal value.

The disadvantage of the known method aimed at improving the image quality of the object is that it does not ensure getting frames with optimal or close to optimal focusing parameters when shooting distant objects, including when atmospheric transparency is medium and below average.

### SUMMARY

When shooting each scene under specific shooting conditions, there is the notion of “focal depth” (FD), the value of which depends both on the specific conditions and shooting parameters, and on the characteristics of the camera. The value of this parameter changes with changing the focal length, opening the diaphragm, the certain distance to the object. Generally, there is a common rule: the greater is distance to the object or the focal length, the bigger is focal depth, and this is why for sufficiently long focusing distances and big focal lengths, the focal depth is sufficiently elongated.

This property of a camera can be used when there is a task of video shooting and monitoring of remote objects, for example, objects close to the horizon, with the maximum cameras' zooming, which is necessary for monitoring forests to detect forest fires. In this case, the objects, especially in adverse weather conditions, have low contrast, which makes it difficult to operate the camera automatic focusing system.

This invention is directed to solve a task of improving methods of producing a photo or video image of an object.

Technically, the result is aimed at improving the quality of focusing of the images produced.

The technical result is achieved due to the fact that in a method of producing a photo or video image of at least one object wherein the image of the object is obtained by means of an optical electronic device, an object related to at least one object is first selected to focus on, while this object complying with the following conditions:
image of the object to focus on is more contrasting against the object;
object is within the boundaries of the depth of the sharply imaged space;
   then an image of at least one object is produced, wherein
the optical electronic device is adjusted to focus on the object to focus on, which corresponds to the object,
the focusing parameters are stored
and used to produce the image of the object.

A digital video camera should be preferably used as an optical electronic device, such as a remotely controlled camera featuring a variable viewing direction, equipped with an auto focus device, and placed on top of a high altitude object.

When receiving photo or video images as the object to focus on, the preferable way is to select an object which is contrasting against the object as high as possible, and which is in the field of view of the optical electronic device in such a way that it is placed within the one frame with the object or in different directions of the camera view. In most cases, it is preferable to choose an object that is closer to the object as an object to focus on, because its contrast is higher due to the lesser influence of the atmosphere. Such an object may be an artificial facility, i.e. a building, a structure that, as a rule, feature higher contrast than natural objects.

The optical electronic device is preferably focused on the object to focus on by the automatic method, and the object is a part, or parts, of a forest area.

### BRIEF DESCRIPTION OF THE DRAWINGS

FIG. 1 shows a video frame of a distant object with low image sharpness (Example 1).

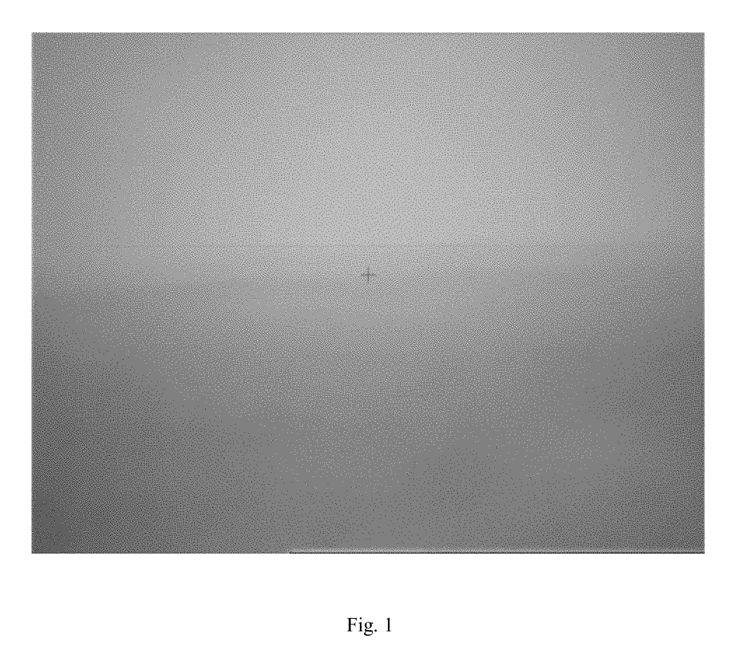

FIG. 2 shows the frame of the video at the moment of focusing on an object to focus on (Example 1).

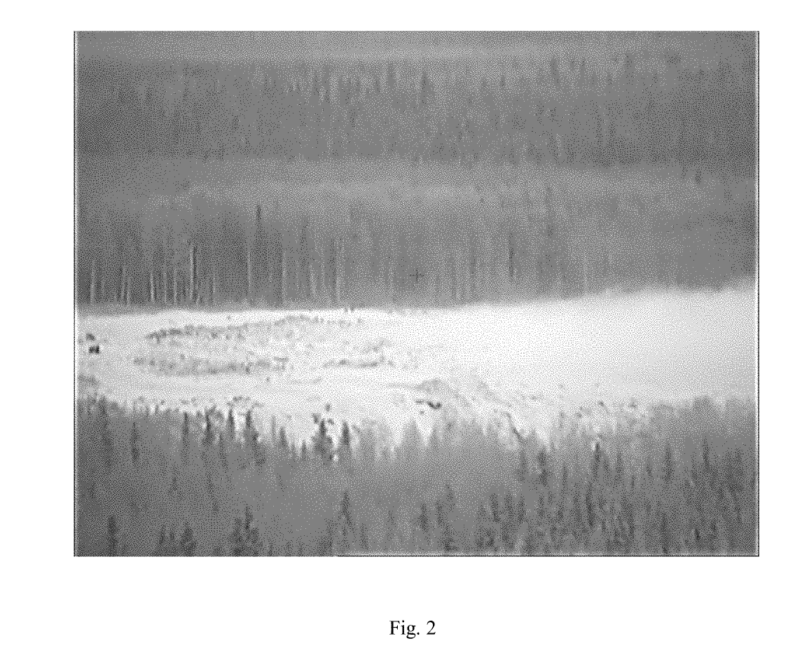

FIG. 3 shows a video frame with close to the maximum possible sharpness of the image for the existing shooting conditions (Example 1).

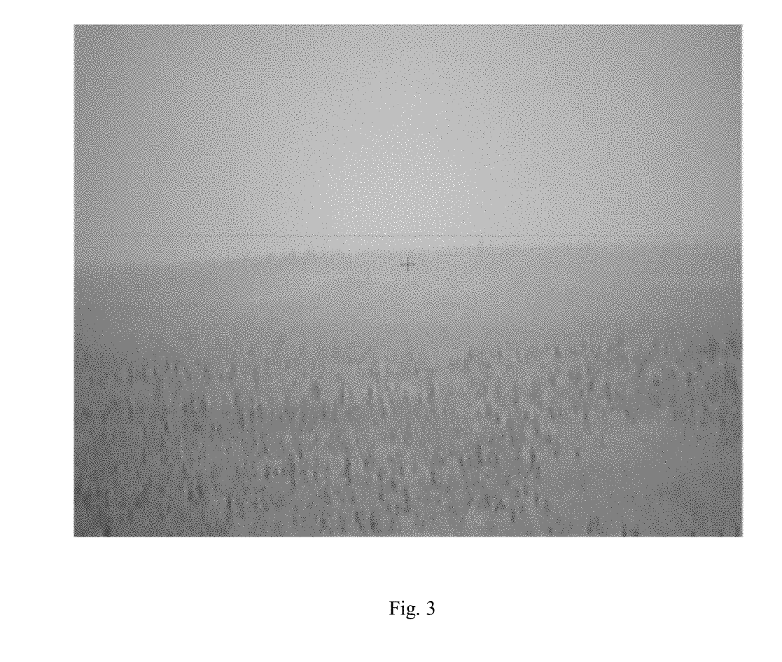

### DETAILED DESCRIPTION OF THE INVENTION

In the claimed method of producing photo or video images of at least one object, for example, video images, images of the objects are produced using an optical electronic device, for example a digital video camera, which is, for example, part of the video monitoring system of the forestland described in RF patent No. 2458407. A remotely controlled video camera equipped with an autofocusing device, with the ability to change the viewing direction, and installed on top of a high-altitude facility, for example on a mast. A distant part of a forestland may be selected as an object for shooting.

In the implementation of the method, an object to focus on is first selected, for example, a separate standing house, which meets the following conditions:
image of the house should be more contrast, for example the most contrasting, with respect to the forest area;
forest part is located within the boundaries of the depth of the sharply imaged space.

At the same time, the house chosen as the object to focus on can be located both in the same frame with the forest area, and in a direction, which is different to the direction of the camera's view.

The object to focus on can be selected by the operator or user of the system in manual mode or automatically. When working in manual mode, the area is observed with the help of the camera, preferably, the parts less distant than the object, to find a contrast object. This can be done by the system operator visually by solving the visual task. Having detected the most contrast object, the operator selects it as the object to focus on. Automatic selection of an object to focus on is carried out using computer vision algorithms (see, for example, [2]).

Simultaneously with the choice of the object for focusing, it should be established, experimentally or by mathematical calculations, whether the object is within the boundaries of the depth of the sharply imaged space when focusing on the house.

The experiment is conducted in good weather, when both the object for focusing and the house are clearly visible, and it is possible to visually determine whether the object is within the focal depth. To do this, the camera should be pointed at the house and the camera is focused in automatic mode. After that, the autofocus mode is disabled on the camera, the focus settings are stored and remain unchanged, that is these parameters are used when receiving the image of the object.

If the sharpness of the image of the object is high and satisfies the user, then at the given parameters of the camera and the lens, the object is within the focal depth, if not, then another object should be selected to focus on, for example, further distanced from the camera, that is closer to the object.

Mathematical methods to determine whether the house is within the boundaries of the depth of the sharply imaged space can be applied in any weather. Additionally, apart from the distance to the object for focusing, the operator must be aware of the camera lens characteristics specified in the formulas for FD boundary definition given in the “Definitions” section of this description.

After selecting the object to focus on that meets the specified conditions, and focusing the camera on it, the image of the object is produced. If it is necessary to produce images of several objects, especially when images of these objects are received at a fixed frequency, it is possible to determine in advance for each of them the object to focus on and to shoot without the stage of determining an object to focus on, which would meet the given conditions, but only in the mode of “focusing on the object to focus on—recording the parameters of focusing—getting the image of the object.” The same scheme works when shooting the same object with different values of the focal length. At the same time, it is advisable to save the parameters of its orientation to the object or objects of focusing in the camera's operation control application after having determined them and afterwards to carry out the focusing procedure in an automatic mode. Also in such cases, it is advisable to save the camera orientation parameters in respect of the object(s).

If more than one part of the forest is within the boundaries of the depth of the sharply imaged space, images of all of them can be produced without additional focusing procedures. For example, you can perform a circular or sectoral shooting of remote forest areas without additional focusing, when the camera's shooting route passes through an equally remoted area.

If during shooting, the distance to the objects changes, and they are beyond the boundaries of the sharply imaged space, it is necessary to focus on the object again, or change the object for focusing. The same thing should be done if the focal length is changed, i.e. the object is zoomed closer or farther.

### Example 1

For video images of the forest, a video monitoring system was used, which is described in RF patent No. 2458407, with the AXIS Q6032E camera manufactured by the Swedish company AXIS, which represents the family of IP PTZ controlled cameras (pan, tilt, zoom). Such cameras, in addition to the standard elements (the optical device and the electronic matrix), include a device that allows the camera to change its direction of view and zoom. In addition, such cameras can be connected to the Internet and feature an interaction interface, through which digital commands can be applied to control the camera. As a protocol providing management, the ONVIF protocol was used:

http://www.onvif.org/Documents/Specifications.aspx.

The camera was fixed at a height of 70 in on top of the communication operator's tower, located at a distance of 5 kin from the object to be monitored (shot): a forestland with dimensions: 10 km along the horizon×3 km. The camera was brought into working order. Weather conditions—temperature—“+25,” dry, slight smoke caused by peat fires without open burning and a clear fireplace.

The remote operator, who is in a specialized control and monitoring center, displayed the image from the camera on the monitor screen. Through a special software interface, he had the ability to remotely control the camera, including: the direction of the view, the multiplicity of the zoom.

The operator pointed the camera at the target forest area in the manual mode. Due to some fogging of the surrounding space and the object, as well as a large distance to the forest, the camera failed to focus automatically on the object (see photo 1).

The operator applied the method of this invention. To do this, he manually selected an object, which was visually the most contrast: a forest belt at a distance of about 300 in from the location of the camera. The negative effect of smoke in this case is not high.

By preliminary mathematical calculations, the operator has determined the boundaries of the FD for the current situation and the available camera parameters.

$${R}_{1} = \frac{{Rf}^{2}}{{f}^{2} + K ( R - f ) z} = \frac{300 * {0.12}^{2}}{{0.12}^{2} + 5 * ( 300 - 0.12 ) * 0.00003} = 72.8$$

A value of R₁ is equal to 72.8 in, which means that the near boundary of the sharply imaged space is located closer to the object of the shooting.

$${R}_{2} = \frac{{Rf}^{2}}{{f}^{2} - K ( R - f ) z} = \frac{300 * {0.12}^{2}}{{0.12}^{2} - 5 * ( 300 - 0.12 ) * 0.00003} = - 0.03$$

The value of R₂ is negative. This means that the far edge of the sharply imaged space is infinitely distanced, that is, the object is in the FD zone.

The camera focused on the forest belt (see photo 2) in the automatic mode, and the operator switched off the autofocus mode. The focus settings were stored.

As the entire forest area was within the boundaries of the depth of the sharply imaged space, then the operator conducted the shooting (monitoring) by changing the direction of the camera's view horizontally, still without changing the focusing parameters. The image was produced with quality parameters of sharpness, which are close to the highest, for the existing shooting conditions (see photo 3).

Automatic selection of the focus object can be implemented by software methods. A panoramic shooting is produced of a terrain located preferably closer to the location of the camera than the object or objects, including potential objects to focus on. The shooting is carried out at a small zoom, for example ×1.5 (in this case there are no problems with focusing) using the camera control application. Next, the acutance and contrast of individual parts (objects) of the final view panorama are analyzed with software means and assess is made which of these objects are the most contrast and acute. Based on the data on the angle of inclination of the camera and the height of its placement, the distance to this object is determined. Based on the obtained data, with known parameters of the camera lens, the FD is determined. Based on the criteria set forth herein for the object for focusing, at least one object is selected to focus on.

Thus, the proposed method for producing photo or video images makes it possible to produce images of objects with improved quality by improving the quality of image focusing.
[1] Sharonov, V.V. Measurement and calculation of the visibility of distant objects/V.V. Sharonov.—M.-L.: OGIZ Gostehizdat.—1947.-284 p.
[2]) Forsythe D., Pons G. Computer vision. The modern approach (2004.-928 p.)

1. A method for producing a photo or video image of at least one object, comprising: imaging the object with the use of an optical electronic device, wherein for at least one object an object is selected to focus on, which corresponds to this object and meets the following conditions:
image of the object to focus on is more contrasting against the object;
object is within the boundaries of the depth of the sharply imaged space;
an image of at least one object is produced, wherein
the optical electronic device is adjusted to focus on the object to focus on, which corresponds to the object,
the focusing parameters are stored
and used to produce the image of the object.

2. The method according to claim 1, wherein a digital video camera is used as the optical electronic device.

3. The method according to claim 1, wherein the remotely controlled camera is used as an optical electronic device.

4. The method according to claim 1, wherein a camera with a variable viewing direction is used as an optical electronic device.

5. The method according to claim 1, wherein a camera with autofocus device is used as an optical electronic device.

6. The method according to claim 1, wherein the optical electronic device is placed on top of a high-altitude object.

7. The method according to claim 1, wherein the object is selected to focus on under good visibility conditions of the object.

8. The method according to claim 1, wherein the object is selected to focus on in such a way that it is in one frame with the object.

9. The method according to claim 1, wherein an object most contrasted with respect to the object is selected as the object to focus on, which is in the field of view of the optical electronic device.

10. The method according to claim 1, wherein the object to focus on is selected in such a way that the object for focusing and the object are in different viewing directions of the optical electronic device.

11. The method according to claim 1, wherein the focusing of the optical electronic device on the object, which is selected to focus on, is performed by an auto focus method.

12. The method according to claim 1, wherein a part of a forestland or parts of it is selected as the object for shooting.

13. The method according to claim 1, wherein the forest parts lying in different viewing directions of the optical electronic device are selected as the object for shooting.

14. The method according to claim 1, wherein an extended object is selected as the object for shooting, and the image of the object is produced by changing the viewing direction of the optical electronic device.

15. The method according to claim 1, wherein the optical electronic device is provided with a zoom lens, and focusing on the object selected to focus on and producing the image of the object is made with a fixed value of the focal length.

16. The method according to claim 1, wherein the viewing direction parameters for at least one object to focus on and at least one object are stored in a video camera control application and used to focus and produce an image of at least one object in automatic mode.
